(19) United States
(12) Patent Application Publication
(10) Pub. No.: US 2010/0281758 A1
(43) Pub. Date: Nov. 11, 2010

(54) One-piece fish hook disgorger and method of use

(76) Inventors: Cori B. McFann, Ludowici, GA (US); Brian L. McFann, Ludowici, GA (US)

Correspondence Address: Richard L. Mikesell, Esq., Suite 216, 14827 Ventura Blvd., Sherman Oaks, CA, 91403, US

(21) Appl. No.: 12/387,894

(22) Filed: May 11, 2009

(51) Int. Cl. A01K 97/18

(52) U.S. Cl. 43/53.5

(57) ABSTRACT

A fish hook removing device which has two fingerholds on a proximal end and which tapers to a rounded point at the distal end thereof A fisherman uses the disgorger of the present invention by using his free hand to grasp the fishing line associated with the hook approximately 1 to 2 feet above the fish and sliding the device over the line then pulling the device down tight to fish's mouth and flipping the fish over the device. With this motion the hook is immediately dislodged. The simple one-piece construction of the device of the present invention makes it less susceptible to damage during storage and still easy and efficient to use.

### TECHNICAL FIELD OF THE INVENTION

The present invention relates to the general art of fishing, and to the particular field of disgorgers.

### BACKGROUND OF THE INVENTION

In the sport of fishing, one of the necessary activities is to remove the fishing hook from the mouth of the fish. This deceptively simple task is typically complicated, however, by a number of concerns. Removing a fish hook from the mouth of a fish can at best be difficult unless the hook is located near the lips of the mouth of the fish where it is readily visible and easily grasped by the hand of the person who is fishing. One basic problem is, of course, that most hooks are barbed and hence specifically designed so that the fish cannot readily expel the hook from its mouth, since after the hook penetrates flesh the barbed portion tends to dig in or penetrate additional flesh when a reverse or rearward pulling force is exerted upon the hook. In spite of the barb or barbs it is still fairly easy to remove the hook from the mouth of the fish if the hook is readily visible which means that the fish is hooked at or near the lips of the mouth.

Unfortunately, all too often the fish swallows the hook so that it is located well beyond the lip area of the mouth of the fish. This is desirable in terms of catching the fish since it is difficult or impossible for the fish to expel the hook from its mouth and hence this usually insures that the fish remains caught when the fish line is reeled in. However, after the fish is caught the hook needs to be removed. In this situation the hook is not readily accessible and may not even be in a location where it can be seen. Merely pulling out on the fish line to attempt to pull the fish hook out will only result in setting the hook in deeper so that it is even more difficult to remove the hook.

Because the slippery surface of the fish does not allow one to leverage the hook from the mouth by using one's fingers alone, a fisherman often resorts to using regular common pliers and needle nose pliers to remove the hook. However, it is quite common for the hook not to be readily visible and in this case it is difficult to grasp the hook with the nose of the pliers. Even if the hook can be grasped with the pliers, it may still be difficult to remove the hook and it may be necessary to pull the hook out by pulling it through the flesh in the mouth of the fish. This can damage or break the hook and in most cases it causes sufficient damage to the fish so that it will die. Consequently, this prevents keeping the fish alive until it is cleaned or returning the fish to the water it came from so that it can grow larger.

Fly fishing is a popular and rapidly growing sport. In this sport, an artificial fly is used as bait. The artificial fly typically comprises a fish hook fabricated with fur, feathers, or the like, in order to resemble an insect, or other forage, preferred by fish. The artificial fly is manipulated in the water to lure and hook the fish.

Once a fish is caught and reeled in, a fisherman removes the fish hook either by hand or with an implement such as forceps, small pliers or the like. At this point, the fisherman may keep the fish or, as is becoming more common, release the fish back into the water. Many waters are regulated so that fish are required to be released. As flyfishing gains in popularity, increasing numbers of lakes and streams are being designated as “catch and release” only areas.

In “catch and release” fishing, the health of the fish after the release becomes a key issue. Research studies have shown a dramatic relationship between the amount of time that a fish is handled as it is being caught and released, and its chances of survival. One study by the University of Ontario, Canada, found an astounding 68% range in mortality rates, with a direct relationship existing between the extent of fish handling, exposure to air during catch and release, and a fish's chances of survival.

There are a number of ways in which a fish's health can be compromised during the catch and release process. For example, the protective coating of slime covering the fish's body may be partially removed during handling by the fisherman, thereby leaving the unprotected areas vulnerable to waterborne infections. The delicate mouth and jaw area, as well as the gill membranes, may be damaged by the fish hook, the implement used to remove the hook, or the hands of the fisherman. The internal organs of the fish may be damaged by squeezing the fish too tightly. In addition, relatively brief exposure to air has been shown to damage gill membranes, causing delayed respiratory shock and death as much as 24 hours after the fish is released back into the water.

In order to insure the highest chances of survival for the fish, it is desirable to catch and then release the fish underwater, with as little physical contact between the fisherman and the fish as possible. It is also desirable to remove the fly from the fish without damaging the fly.

However, prior art fish hook removers do not adequately address these concerns. Typical prior art fish hook removers used by fishermen include devices designed to grab the shank, or straight part of the fish hook, with a clamping action. The fish hook and fly is then twisted, pushed, or pulled out of its engagement with the fish's mouth. A major drawback to using such a tool is that, as the hook is grabbed by the clamping type device, the delicate materials from which the fly is fabricated are often damaged. The clamping of the fly, along with the twisting and pushing forces, can tear apart the fly and render it useless. If that occurs, a new fly must be tied onto the fishing line before the fisherman can resume his pursuit.

Another drawback with these clamping type devices is that they are cumbersome to use, thereby making it difficult to grab the fly, which is often extremely small, when caught in the mouth of a live flapping fish. The fish usually must be held still, often with some force, in order to grab the fly with the clamping type device. In order to accomplish the removal of the fish hook, the fisherman typically ends up handling the fish so that the fish is immobilized during removal.

Another drawback of typical prior art fish hook removers is that, because of the difficulty in clamping onto the fish hooks, it is likely that both hands will be required to facilitate the fish hook removal. This is because a live fish usually makes a great effort to regain its freedom and is continuously moving. A typical way of landing a fish is to use a fish net, or to grab the fishing line. The fishing rod is then set aside, and both hands are used to perform the tasks of fish restraint and hook removal.

Furthermore, certain prior art fish hook removal devices appear to be designed for bait fishing purposes. An important distinction between flyfishing and baitfishing is that in flyfishing, the fish is usually hooked in the outer portion of the mouth or jaw, whereas in baitfishing, the fish is usually hooked deep in the throat. One reason for this difference may be because a fish, having taken up a hook baited with an edible material, will in most cases swallow the baited hook. On the other hand, a fish taking up an artificial fly is able to perceive the deception once the fly is in its mouth, either from the unnatural texture or the absence of the appropriate scent or taste, and immediately attempts to “spit out” the fly. This is why a flyfisherman often has only a brief instant, when the fish takes up the fly, to apply pressure to the rod and thereby “set the hook”.

Therefore, there is a need for a disgorging device that does not require the fisherman to contact the fish during the hook disgorging operation.

Furthermore, since the hook disgorging operation may be carried out during inclement weather or under less than ideal conditions, the disgorger should be as easy to use as possible.

Therefore, there is a need for a device for removing a fish hook from a hooked fish which is easy and efficient to use and which does not require the fisherman to touch the fish.

Furthermore, disgorgers are generally stored in a tackle box and thus may be subject to damage during storage. A damaged disgorger may be useless and will not generally be discovered until the device is needed, which is inconvenient at best. Therefore, there is a need for a disgorger that is not subject to damage during storage.

### SUMMARY OF THE INVENTION

These, and other, objects are achieved by a fish hook removing device which has two fingerholds on a proximal end and which tapers to a rounded point at the distal end thereof. Use of the device embodying the principles of the present invention includes using the fisherman's free hand to grasp the fishing line associated with the hook approximately 1 to 2 feet above the fish and sliding the device over the line then pulling the device down tight to fish's mouth and flipping the fish over the device. With this motion the hook is immediately dislodged.

The simple one-piece construction of the device of the present invention makes it less susceptible to damage during storage and still easy and efficient to use.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a fish with a hook embedded therein.

FIG. 2 is a perspective view of a hook disgorger embodying the principles of the present invention.

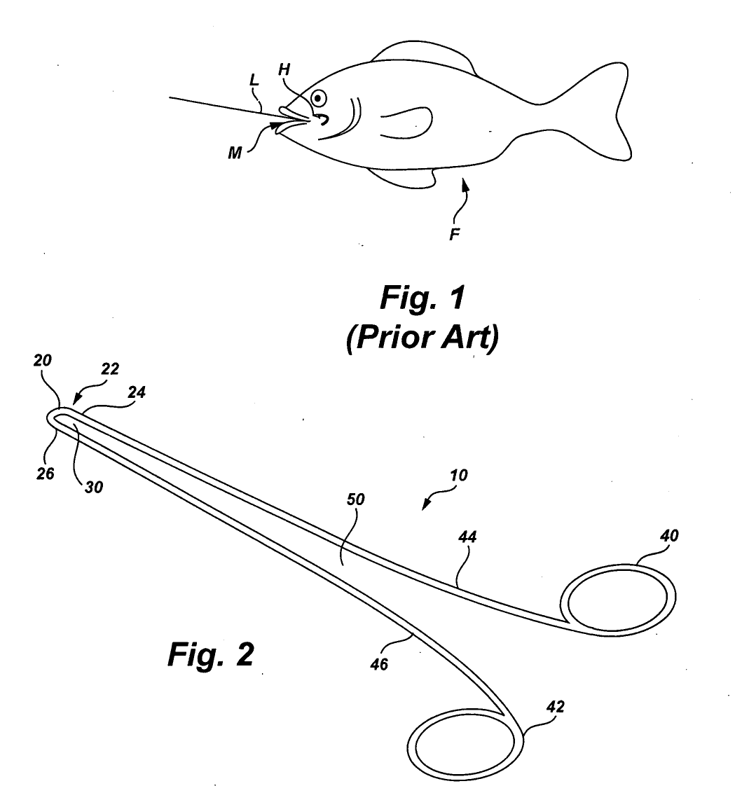

### DETAILED DESCRIPTION OF THE INVENTION

Referring to the figures, it can be understood that the present invention is embodied in a device 10 that is used to disgorge a hook H from a fish F via the fish's mouth M without requiring the fisherman to touch the fish. Hook H is associated with a fishing line L.

Device 10 is one piece and has a rounded tip 20 on a distal end 22 thereof and which has two end areas 24 and 26. The end areas are not separate elements and are designated end areas for the sake of description and not for the sake of limitation. Each end area of the rounded tip is spaced apart from the other end area to define a gap 30 between the end areas of the tip for a purpose which will be understood from the teaching of this disclosure.

Each end area is connected to a circular fingerhold, designated in FIG. 2 by reference numerals 40 and 42. The fingerholds are one-piece with corresponding flexible bodies 44 and 46 which connect the fingerholds with the corresponding end areas of the tip. The fingerholds thus form a proximal end of device 10. The bodies 44 and 46 are spaced apart from each other for the entire distance between the tip and the fingerholds to define a gap 50 which is contiguous with gap 30 and represent a continuation thereof.

The entire device 10 is one piece and planar so it is not likely to be damaged during storage and is scissorlike whereby it is quite easy and efficient to use, even under adverse conditions.

Device 10 is used by grasping fishing line L associated with hook H approximately 1 to 2 feet above the fish, positioning the line in gaps 30 and/or 50, sliding the device over the line until it engages mouth M of the fish, pulling the device down tight to fish's mouth, moving the fingerholds toward each other to decrease gaps 30 and 50 until the bodies of the device contact hook H, and then flipping the fish over the device. The fish is never touched during the entire process and the hook will be dislodged during the flipping motion.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A device for removing a fish hook from a fish without touching the fish comprising:
a scissorlike device;
a flexible rounded tip on a distal end of the device;
two spaced apart fingerholds on a proximal end of the device, the fingerholds being forced toward each other when the device is used to remove a hook from a fish;
a flexible body associated with each fingerhold, each flexible body connecting a fingerhold to an associated side of the rounded tip;
the flexible bodies being spaced apart from each other and being forced toward each other
when the fingerholds are forced toward each other so a fish hook will be contacted by the bodies adjacent to the tip when the device is used to remove the fish hook from a fish.

2. The device defined in claim 1 wherein the device is one piece.

3. The device defined in claim 2 wherein the bodies are spaced apart from each other for the entire distance between the tip and the fingerholds, the fingerholds and the bodies associated therewith being spaced apart from each other whereby no contact occurs between the spaced apart fingerholds or the bodies during use of the device.

4. The device defined in claim 3 wherein the fingerholds are circular.

5. The device defined in claim 4 wherein the device is planar.

6. A method of removing a fish hook from a fish comprising:
providing a scissorlike device with two spaced-apart fingerholds on a proximal end thereof;
providing the device with a flexible rounded tip on a distal end thereof;
connecting each fingerhold to the tip with a flexible body;
spacing the flexible bodies apart from each other adjacent to the tip;
without touching a fish that has been hooked, locating a fishing line associated with the hook between the two bodies adjacent to the rounded tip;
without touching the fish, sliding the device along the fishing line until the device engages the fish;
forcing the two fingerholds toward each other until the bodies engage the hook; and
without touching the fish, flipping the fish over while maintaining the bodies in contact with the hook to remove the hook from the fish.
